(19) United States
(12) Patent Application Publication
(10) Pub. No.: US 2019/0136087 A1
(43) Pub. Date: May 9, 2019

(54) Radiation Curable Silicone-Epoxy Resins

(71) Applicant: Evonik Degussa GmbH, Essen (DE)

(72) Inventors: DIRK HINZMANN, PULHEIM (DE); ALEXEY MERKULOV, MARL (DE); FELIX JAEHNIKE, BOCHUM (DE); DUY VU PHAM, OBERHAUSEN (DE)

(73) Assignee: Evonik Degussa GmbH, Essen (DE)

(21) Appl. No.: 16/096,027

(22) PCT Filed: Apr. 11, 2017
(86) PCT No.: PCT/EP2017/058687

§ 371 Date: Oct. 24, 2018

(30) Foreign Application Priority Data
Apr. 27, 2016 (EP) 16167201.9

(51) Int. Cl. C09D 183/10; C08G 59/16; C08G 77/42; C08L 83/04; C09D 163/00

(52) U.S. Cl. CPC C09D 183/10; C08G 59/1461; C08G 77/18; C08L 83/04; C09D 163/00; C08G 77/42

(57) ABSTRACT

The invention relates to radiation curable silicone-epoxy resins, coating compositions containing said resins and to the use of these coating compositions for producing protection or dielectric layers in semiconductor elements.

### CROSS REFERENCE TO RELATED APPLICATIONS

This application is a 35 U.S.C. § 119 patent application which claims the benefit of European Application No. 16167201.9 filed Apr. 27, 2016, which is incorporated herein by reference in its entirety.

### FIELD

The present invention relates to new silicone-epoxy resins which are suitable for producing protective layers in particular for semiconductor layer constructions, to coating compositions comprising them and to their use.

### BACKGROUND

The modern semiconductor and display industry is endeavouring to simplify operations so as to make the individual electronic component layers in its respective components more favourably priced and more available. For this reason it is focusing intensely on various methods allowing the respective electronic component layers to be produced. Of particular interest in this sense are especially methods for applying layers from the gaseous or liquid phase.

Aside from their production method, however, it is also essential that each of the functional layers applied can be protected from subsequent mechanical or chemical exposure (e.g. during cleaning or by patterning etchants). Also very important is the protection of each of the functional layers from unwanted interaction with other layers or with the atmosphere. A great desire, finally, is that the functional layers, in order to impart high thermal stability, be provided with a protective layer allowing the functional layers to withstand temperatures even of up to 400° C. during further processing. Such functional layers are designated differently according to the desired function, as passivation layer or etching stop layer, for example. In general, though, the desire is for the protective layers to meet all of the above-stated requirements.

Materials in current use in the art are hard, silicon-containing layers, especially layers of silicon oxide, silicon nitride and silicon carbide. But to date their application has often been costly and inconvenient, involving vacuum technologies such as CVD or PVD. So that the protective layers are themselves in structured form, they require subsequent patterning, in elaborate lithographic dry-etching procedures. Accordingly, the industry is seeking processes and new materials useful therein to enable simpler production of such protective layers.

JP S59-081369 A describes protective layers producible from coating compositions containing silicone-modified epoxy resins. A drawback with the epoxy resins it describes, though, is the need for conventional crosslinkers such as phenolic novolaks, melamine resins, phthalic anhydrides, amines or BF₃/amine complexes to be added to them.

EP 0 263 237 A2 discloses silicone-modified epoxy resins preparable by reaction of double bond-containing epoxy resins with double bond-containing silicones in the presence of a radical initiator. The resulting epoxy resins are exclusively thermoplastic coatings. Since, moreover, exclusively linear polydimethylsiloxanes are used, the resulting coating materials are of low thermal stability in view of their low degree of crosslinking.

There is therefore interest in easier-to-cure coating compositions with better properties. Of particular interest are radiation-curing coating compositions, since they have the advantage that they are especially easy to structure by irradiation.

EP 0 617 094 A1, for example, discloses coating materials comprising organopolysiloxanes with (meth)acrylic ester groups, which are radiation-curable on account of the (meth)acrylate groups they contain. The organopolysiloxanes described are disadvantaged, however, by inadequate chemical resistance towards etchants, for example.

DE 38 20 294 C1 discloses radiation-curing polysiloxanes preparable from polysiloxanes having epoxy groups attached via SiC bonds, and subsequent complete reaction of the epoxy groups with (meth)acrylic acid and monocarboxylic acids without double bonds. The polysiloxanes used can be prepared, for example, by addition of allyl epoxypropyl ether onto α,ω-hydrogendimethylpolysiloxane. A drawback, though, of radiation-curing polysiloxanes derived from such polysiloxanes having epoxy groups attached via Si—C bonding is their lack of adequate chemical resistance, towards etchants, for example.

Etchants in the sense of the present invention are compounds which alter the surface of the material being etched, in a chemical reaction—by oxidation, for example—and so cause it to dissolve. Etchants may be acids, bases or oxidants.

EP 0 281 681 B1 likewise discloses radiation-curing polysiloxanes having (meth)acrylic ester groups bonded via SiC groups. But the SiC bond-mediated attachment of the (meth)acrylate groups gives these polysiloxanes too an insufficient chemical resistance, towards etchants, for example.

### SUMMARY

The problem addressed in the present document is therefore that of avoiding the above-described disadvantages of the prior art. A particular problem is that of providing particularly readily structurable coating materials that can be used to provide layers which confer particularly good protection from mechanical, chemical and/or thermal exposure and also from interaction with other layers and/or the atmosphere on layers, the semiconductor component layers or entire semiconductor components.

### DETAILED DESCRIPTION

The stated problem is presently solved by the radiation-curable silicone-epoxy resins of the invention, which are preparable by the process of the invention comprising the steps of polycondensation of at least one alkoxy-functional silicone resin with at least some of the primary or secondary hydroxyl groups of a cycloaliphatic or aromatic epoxy resin, and (preferably subsequent) reaction of unreacted oxirane groups, from (cycloaliphatic or aromatic) epoxy resin attached to the silicone resin, with at least one unsaturated carboxylic acid.

A radiation-curable silicone-epoxy resin in the context of the present invention is a resin which is curable with electromagnetic radiation, preferably with UV radiation of the wavelength 100 to 380 nm.

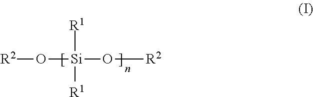

in which R¹ independently at each occurrence may be an alkyl, aryl, alkoxy, hydroxyl or —OSi(R³)₃ group, where R³ independently at each occurrence may be an alkyl, aryl, alkoxy or hydroxyl group, and where R² independently at each occurrence may be hydrogen or an alkyl or aryl group, preferably an alkyl group, very preferably a methyl group or ethyl group, and n is >1, with the proviso that at least one of the radicals R¹ or R³ is a hydroxyl or alkoxy group, preferably an alkoxy group, and/or, preferably or, at least one of the radicals R² is an alkyl group or hydrogen, preferably an alkyl group.

Preferably, the number-average molecular weight Mₙ of the alkoxy-functional and optionally silanol-functional polysiloxane is between 300 to 5100 g/mol, preferably 400 to 3000 g/mol, very preferably 450 to 1800 g/mol. The determination is made by means of gel permeation chromatography (GPC), as disclosed below in the Methods used.

Alkyl radicals suitable preferably as R¹, R² and R³ are linear or branched alkyl radicals having 1 to 18 C atoms, i.e. C₁-C₁₈ alkyl radicals. Particularly preferred radicals R¹, R² and R³ are —CH₃ and —CH₂CH₃ radicals, i.e. methyl and ethyl groups.

Aryl radicals suitable preferably as R¹, R² and R³ are those having 6 to 18 C atoms, i.e. C₆-C₁₈ aryl radicals. Particularly preferred are —C₆H₅ radicals, i.e. phenyl groups.

Alkoxy groups suitable preferably as R¹ and R³ are linear or branched alkoxy groups having 1 to 18 C atoms, i.e. C₁-C₁₈ alkoxy radicals. Particularly preferred radicals are —OCH₃ and —OCH₂CH₃, i.e. methoxy groups and ethoxy groups.

In formula (I), n is >1, meaning that the alkoxy-functional and optionally silanol-functional polysiloxane has at least two —Si(R¹)₂—O— units; preferably n is =4 to 70.

The alkoxy-functional and optionally silanol-functional polysiloxanes of formula (I) that are used with particular preference are preferably those where R¹=—CH₃ and/or —C₆H₅ and are therefore phenyl-methylpolysiloxanes, more preferably methoxy-functional or ethoxy-functional phenyl-methylpolysiloxanes, i.e. those where R²=—CH₃ and/or —C₂H₅, since they are available commercially and can be induced to cure sufficiently rapidly even at room temperature≈25° C.

The alkoxy content of the alkoxy- and optionally silanol-functional silicone resin is preferably between 5 and 30 wt %, preferably between 8 and 25 wt %, very preferably between 10 and 20 wt %, based in each case on the total mass of radiation-curable silicone-epoxy resin. The determination is made via ¹H- or ¹³C-NMR-spectroscopic measurements. Higher alkoxy contents denote lower molar masses and hence lower viscosities. This is advantageous since in this way the pourability of the silicone-epoxy resin of the invention in coating compositions is improved in comparison to high molecular mass resin substances.

Epoxy resins used for the polycondensation may in principle comprise all those having at least one primary or secondary hydroxyl group and having cycloaliphatic and/or aromatic groups.

The cycloaliphatic or aromatic epoxy resin may preferably be an organic resin containing epoxide groups of the general formula (X1) or (X2), where m is preferably =1-20.

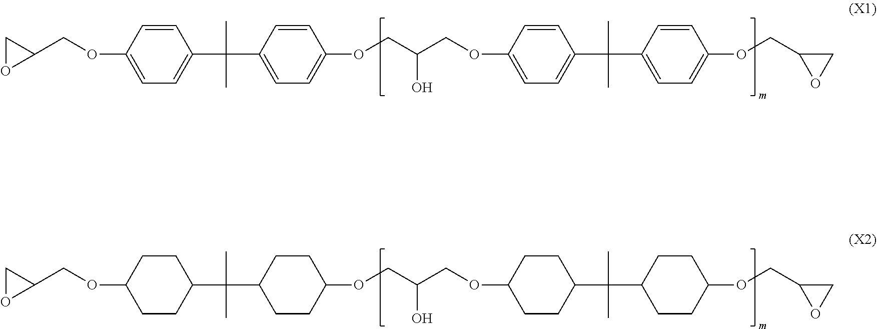

The resins of the general formulae (X1) and (X2) may have the widest variety of different molecular weight distributions.

Preferred epoxy resins are cycloaliphatic or aromatic diethers or polyethers. Particularly preferred are epoxy resins having two epoxide groups per molecule, deriving from bisphenol A, i.e. BPA, or from hydrogenated bisphenol A. One particularly preferred epoxy resin is hydrogenated BPA diglycidyl ether. Corresponding compounds are available commercially, for example, as commercial products, such as ipox ER 15 from ipox, Eponex Resin 1510 from Momentive, or Epalloy 5000 or Epalloy 5001 from CVC Thermoset Specialties. As aromatic epoxy resins it is possible, for example, to use resins from Momentive, represented here by Epikote 1001 and Epikote 1007, or from Dow Chemical, e.g. D.E.R 331.

The reaction of epoxy resin and silicone resin may take place as follows: The reaction is preferably carried out at temperatures of 150 to 200° C., over a period of 3 to 10 hours, with assistance from suitable transesterification catalysts, such as, for example, zirconates (Zr(OR)₄), titanates (Ti(OR)₄) or analogous aluminium compounds (Al(OR)₃), where R=linear or branched alkyl radical with 1 to 8 C atoms, and/or from acidic or basic catalysts. Where diglycidyl compounds are used, moreover, the reaction of silicone resin with the primary or secondary hydroxyl group from the epoxy resin takes place preferably in a molar ratio of 30-50 mol %, based on the components present.

The unreacted oxirane groups of the epoxy resin are subsequently reacted with an unsaturated carboxylic acid. Unsaturated carboxylic acids here are carboxylic acids, preferably monocarboxylic acids containing double and/or triple bonds. Monocarboxylic acids containing double bonds are preferred. Especially preferred are acrylic acid and methacrylic acid.

This reaction takes place preferably at elevated temperatures and in the presence of a transition metal catalyst, preferably at temperatures of 50 to 150° C. and in the presence of suitable catalysts, selected from acids, Lewis acids, bases or Lewis bases, such as chromium(III) carboxylates, for example, where the carboxylate radical may be linear or branched and has up to 8 C atoms.

The silicone epoxy resin formed in the reaction is radiation-curable by virtue of the inserted double and/or triple bonds.

Preferred radiation-curing silicone-epoxy resins of the invention can be subsumed under the formula (IIa) or (IIb) shown below,

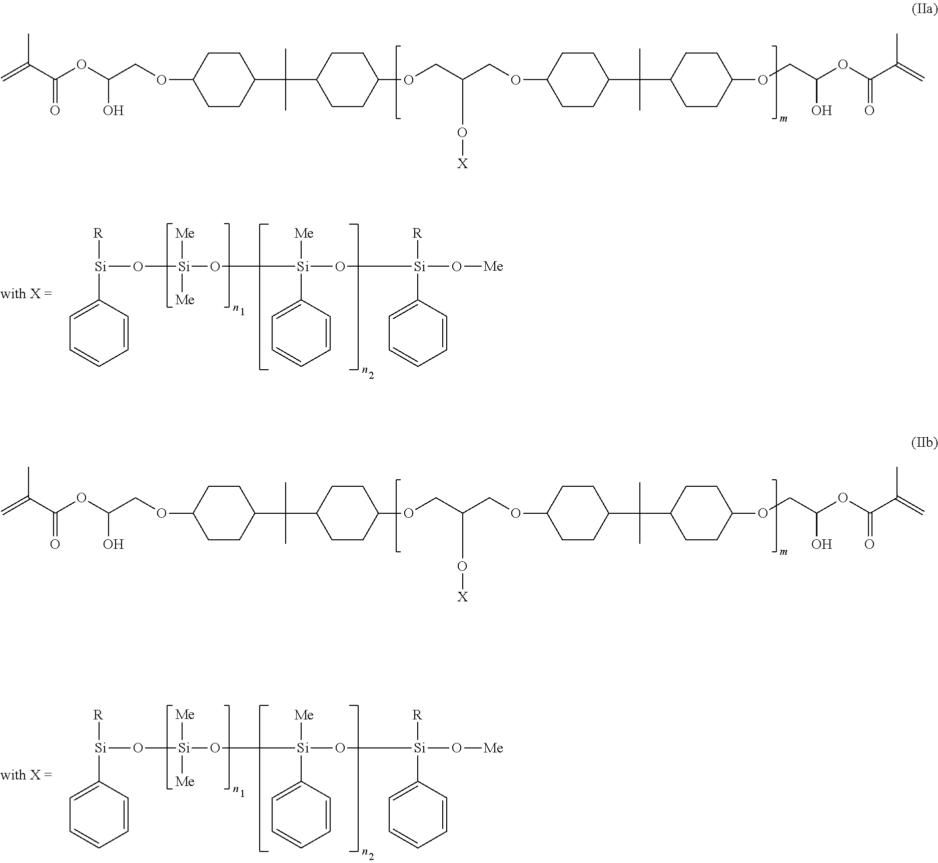

with R being identical or different, linear or branched alkyl radicals with 1 to 18 C atoms, n₁ is between 4 and 70, n₂ is between 4 and 70, and the sum of n from n₁+n₂ is between 4 to 70, and with m=1-20. Particularly preferred radiation-curing silicone-epoxy resins of the invention are those of the formula (IIb).

The radiation-curing silicone-epoxy resins of the invention are very suitable for the production of radiation-curing coating compositions. The present invention therefore also provides coating compositions comprising a radiation-curable silicone-epoxy resin of the invention.

The coating composition advantageously also has other constituents. The coating composition preferably has at least one solvent selected from the group of the esters, ketones, aromatics and alcohols. The coating composition of the invention contains the solvent preferably in weight percentage fractions of 10-50 wt %, based on the total mass of the coating composition. Particularly preferred solvents are 1-methoxy-2-propyl acetate, butan-2-one, acetone, butyl acetate and ethyl lactate.

More preferably it comprises at least one radical-forming photoinitiator. One photoinitiator which can be used with preference is diphenyl(2,4,6-trimethylbenzoyl)phosphine oxide, CAS Reg. No. 75980-60-8.

The silicone-epoxy resins of the invention and the coating compositions of the invention are suitable for a multiplicity of applications. The silicone-epoxy resins of the invention are especially suitable for producing protective or dielectric layers in semiconductor elements. In that application they are able in particular to provide protection from mechanical, chemical and/or thermal exposure and also from interaction with other layers and/or with the atmosphere.

Methods Used:

Spectroscopic Analyses:

The recording and interpretation of NMR spectra is known to the person skilled in the art. A reference that may be mentioned is the book “NMR Spectra of Polymers and Polymer Additives”, A. Brandolini and D. Hills, 2000, Marcel Dekker, Inc. The spectra were acquired with a Bruker Spectrospin spectrometer at room temperature, the measuring frequency during acquisition of the proton spectra was 399.9 MHz. The silicone compounds were dissolved using suitable deuterated solvents such as deuterochloroform or acetone-d₆ (Sigma-Aldrich). The ¹H-NMR signal evoked by the non-deuterated portion of the deuterated solvent is assigned a chemical shift of 2.04 ppm in the case of deutero-acetone or 7.24 ppm in the case of deutero-chloroform. In this way the frequency axis for the entire spectrum was clearly specified. The methoxy value was determined here using the signal of the methyl protons of the methoxy group at 3.4 ppm.

Determination of Double Bond Content by Means of Iodine Number

The amount of C═C multiple bonds may be determined, for example, by determining the iodine number. One common method is to determine the iodine number according to Hanus (Method DGF C-V 11 a (53) of the Deutsche Gesellschaft für Fettwissenschaft e.V.). The values reported below are based on this method.

Determination of Epoxide Equivalent Weight

The epoxy ring is opened in a strictly non-aqueous medium with hydrochloric acid, to form a C—Cl and a C—OH function. The excess hydrochloric acid is back-titrated with ethanolic potassium hydroxide solution, taking account of a blank value which is run in parallel. The method described is used for quantitative determination of epoxy oxygen, as for example in epoxy-functional siloxanes and in the absence of acidic compounds.

The reporting of the epoxide equivalent weight allows the calculation of the amount of unsaturated carboxylic acid required, acrylic acid for example, which eventually forms the radiation-curable groups in the silicone-epoxy resin of the invention.

The fraction of epoxy functions in the intermediate silicone-epoxy resin, which is converted subsequently into corresponding acrylate functions by ring-opening of the oxirane groups using unsaturated carboxylic acid, acrylic acid for example, influences the nature and density of the crosslinking of the radiation-curable silicone-epoxy resin of the invention, and therefore its eventual physical properties.

Determination of Acid Number

The acid number is determined in accordance with ISO 3682 or ASTM D 974, or DIN EN ISO 2114, where the sample was dissolved in a suitable solvent and the acids present are titrated with aqueous potassium hydroxide solution. Acid number (AN) indicates the mg of KOH required to neutralize the free acids present in 1 g of product.

Viscosity

Viscosities were determined by using a Brookfield LV-DV-I+ spindle viscometer. Brookfield viscometers are rotary viscometers with defined spindle sets as rotary bodies. The rotary bodies n used were from an LV spindle set. Owing to the temperature dependence of viscosity, the temperatures of the viscometer and of the measuring liquid were kept constant during the measurement, with an accuracy of +/−0.5° C. Further materials used in addition to the LV spindle set were a thermostatable waterbath, a 0-100° C. thermometer (scale divisions 1° C. or smaller) and a timer (scale values not greater than 0.1 second). For the measurement, 100 ml of the sample were charged to a wide-necked flask; the measurement was made under temperature-controlled conditions and in the absence of air bubbles, after prior calibration. The viscosity determination was carried out by positioning the viscometer in relation to the sample in such a way that the spindle was immersed in the product up to the mark. The measurement is initiated by activation of the start button, while care was taken to ensure that the measurement took place in the favourable measurement region of 50% (+/−20%) of the maximum measurable torque. The result of the measurement was displayed by the viscometer in mPas, while division by the density (g/ml) gives the viscosity in mm2/s.

Determination of Relative Molar Mass of a Polymer Sample by Gel Permeation Chromatography (GPC):

The gel permeation chromatography analyses (GPC) took place with a Hewlett-Packard 1100 instrument, using an SDV column combination (1000/10 000 Å, each 65 cm, internal diameter 0.8 cm, temperature 30° C.), THF as mobile phase with a flow rate of 1 ml/min and with an RI detector (Hewlett-Packard). The system was calibrated against a polystyrene standard in the 162-2 520 000 g/mol range.

Inert Method

Under “inert” conditions is meant that the gas space within the apparatus is filled with an inert gas, e.g. nitrogen or argon. This is achieved by the flooding of the apparatus, with a gentle inert gas stream ensuring inert conditions.

### Working Examples

Synthesis of an Alkoxy-Functional Methyl-/Phenyl-Silicone Intermediate

A reaction vessel was charged under inert conditions with 303 g of phenyltrimethoxysilane, 18 g of methanol and 51 g of silicone cycle mixture, comprising cyclotetradimethylsiloxane, cyclopentadimethylsiloxane, and 1000 ppm of hydrochloric acid (37.5%), and this initial charge was heated to 60° C. with supply of nitrogen. 27 g of water were added dropwise and the batch was held at 80° C. under reflux for 3 hours. The methanol formed was subsequently removed by distillation.

The characteristic numbers obtained were as follows:

Solids content: 100 wt %

Methoxy content: 16.5 wt %

Viscosity: 250 mPa*s

Molecular weight: Mn 890 g/mol/Mw 1193 g/mol/polydispersity 1.34

A1.2 Synthesis of a Silicone-Epoxy Acrylate Resin

A reaction vessel was charged under inert conditions with 129 g of the methoxy-functional methyl/phenyl-silicone intermediate prepared under A1.1, 129 g of IPOX ER 15 (hydrogenated BPA diglycidyl ether from Ipox® chemicals), and this initial charge was heated at 180° C. with supply of nitrogen, with a top-mounted column attachment to separate off the alcohol formed during the reaction. A reaction time of seven hours was followed by cooling to 80° C. The epoxide equivalent weight is 486 g/mol.

Subsequently, under inert conditions, 37 g of acrylic acid and 500 ppm of chromium(III) 2-ethylhexanoate are added. The temperature is raised to 100° C. and held for 4 hours.

The characteristic numbers obtained were as follows:

Solids content: 100 wt %

Viscosity: 60 000 mPa*s

DB equivalent: 570 g/mol (double bond equivalent weight)

Acid number: <2 mg KOH/g

A1.3 Production of a Coating Composition

For spin coating, 3 g of the silicone-epoxy acrylate resin from A1.2, 5 g of 1-methoxy-2-propyl acetate and 0.3 g of diphenyl(2,4,6-trimethylbenzoyl)phosphine oxide were combined at room temperature.

A1.4 Production of a Patterned Etching Stop Layer

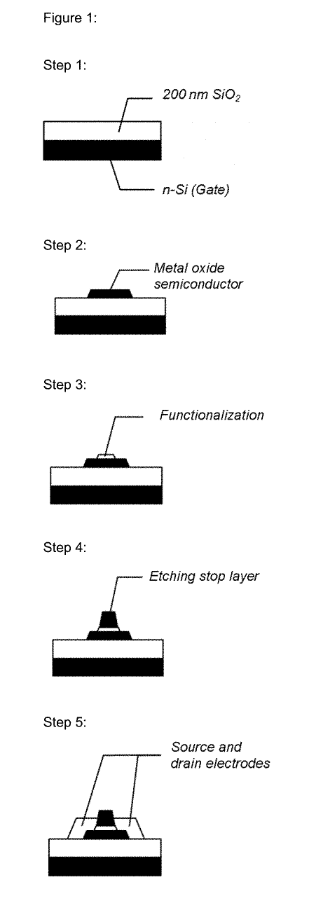

100 μL of the formulation prepared under A1.3 were applied by spin coating (2000 rpm, 30 s) to the 2 cm×2 cm substrate. Exposure was preceded by prebake at 150° C. for 1 minute on a hotplate. The substrate was subsequently irradiated with 365 nm UV light, the i-line of an Hg vapour lamp, through a photomask for 50 s, with radical crosslinking taking place at free areas (negative resist). In order to crosslink these regions more strongly, the sample was postbaked at 150° C. for 40 s. The regions not crosslinked were rinsed off with a solvent (FIG. 1 step 4). In the present case, acetone was used. So that the silicone-epoxy resin is resistant to the etching solution for the metal contacts, the layer was cured at higher temperature of 250° C. for 30 minutes (hardbake). It was found that the silicone-epoxy resin thus treated protects the underlying semiconductor from acids for a longer time, e.g. from 1M oxalic acid for at least 10 minutes at 40° C., from a mixture of 80% H₃PO₄ and 30% H₂O₂ in a volume ratio of 50%:50% for at least 5 minutes at room temperature, or from a mixture of 80% H₃PO₄ and 70% HNO₃ and 99% CH₃COOH and H₂O in a volume ratio of 70%:3%:3%:24% for at least 5 minutes at room temperature.

B1. Use as Etching Stop Layer

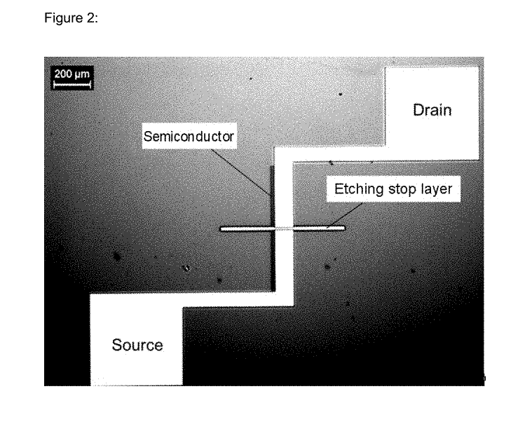

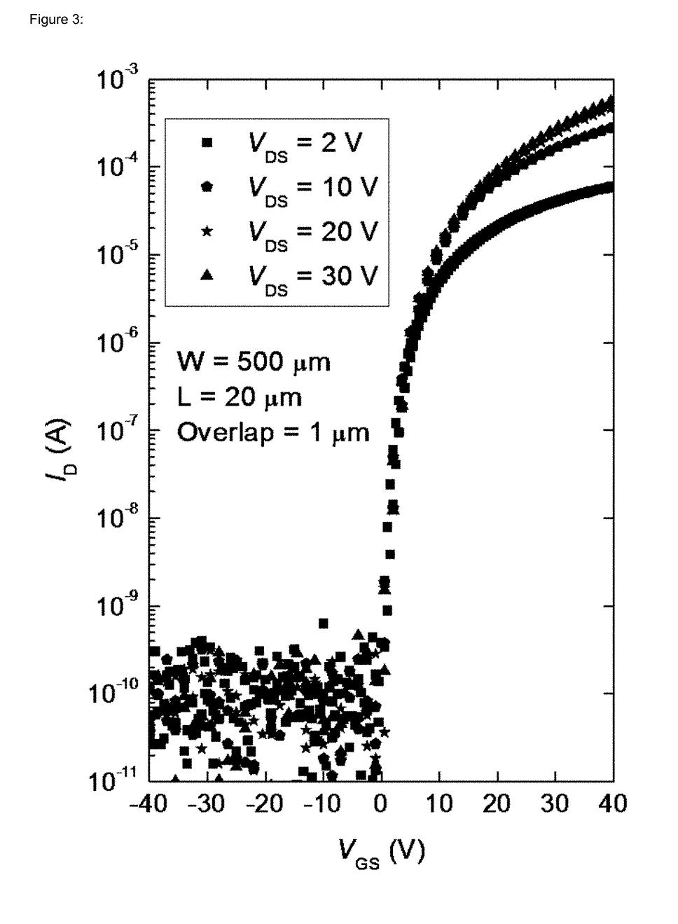

At the start, a metal oxide semiconductor was produced on a silicon substrate with a 200 nm layer of thermally oxidized silicon dioxide (FIG. 1 step 1). For this purpose, an indium oxoalkoxide was deposited by spin coating and converted on a hotplate. The layer was etched in defined areas. For this purpose, a commercially available photoresist, sensitive for example in the wavelength range of a Hg vapour lamp, the so-called g, h and i lines, such as AZ1514H from Clariant AG, for example, was applied and patterned using UV lithography. The etching took place in 1M oxalic acid (FIG. 1 step 2). Additionally, a functionalizing layer of yttrium oxoalkoxide was applied by spin coating, converted to the oxide-containing layer on the hotplate, and patterned in the same way (FIG. 1 step 3). Subsequently, silicone-epoxy acrylate resin was applied as an etching stop layer in accordance with A1.4 and was patterned in such a way that the subsequent channel region of the transistor is protected, so that the semiconductor was not damaged when the metal contacts for source and drain were etched (FIG. 1 step 4). After the curing of the etching stop layer, cathodic sputtering was used to deposit a metal layer (e.g. 250 nm Al or 150 nm Mo) over the whole area of the substrate. To define the contacts for the source and drain electrodes, a layer of the commercially available photoresist AZ1514H was applied and was patterned by UV light with a wavelength of 365 nm, the i line of a Hg vapour lamp. The metal was subsequently etched with a mixture of different acids, as for example a mixture of 80% H₃PO₄ and 30% H₂O₂ in a volume ratio of 50%:50% for 5 minutes at room temperature, or a mixture of 80% H₃PO₄ and 70% HNO₃ and 99% CH₃COOH and H₂O in a volume ratio of 70%:3%:3%:24% for 5 minutes at room temperature (FIG. 1 step 5 and FIG. 2). The completed TFT was characterized electrically under a nitrogen atmosphere (for transfer curves see FIG. 3).

1. A process for preparing a radiation-curable silicone-epoxy resin, comprising the steps of
a. polycondensating an alkoxy-functional silicone resin with a primary or secondary hydroxyl group of a cycloaliphatic or aromatic epoxy resin wherein the cycloaliphatic or aromatic epoxy resin comprises unreacted oxirane groups, and
b. subsequent reaction of unreacted oxirane groups with at least one unsaturated carboxylic acid.

2. The process according to claim 1, wherein the alkoxy-functional silicone resin has the formula 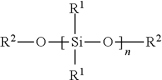
where R¹=alkyl-, aryl-, alkoxy-, HO—, (R³)₃SiO—,
R²=H—, alkyl-, aryl-,
R³=alkyl-, aryl-, alkoxy-, HO—
and n>1, wherein the radicals R¹ or R³ is a hydroxyl or alkoxy group.

3. The process according to claim 2, wherein at n=4-70.

4. The process according to claim 3, wherein it has a number-average molecular weight Mₙ of 300 to 5100 g/mol.

5. The process according to claim 2, wherein R¹ is —CH or —C₆H₅ and R² is-CH₃ or —C₂H₅.

6. The process according to claim 1, wherein the alkoxy content of the silicone resin is 5-30 wt %.

7. The process according to claim 1, wherein the epoxy resin is ring-hydrogenated BPA diglycidyl ether.

8. The process according to claim 1, wherein the carboxylic acid is acrylic acid or methacrylic acid.

9. A silicone-epoxy resin comprising the radiation-curable silicone-epoxy resin made by the process of claim 1.

10. The silicone-epoxy resin, according to claim 9, wherein it has the general formula (11b) 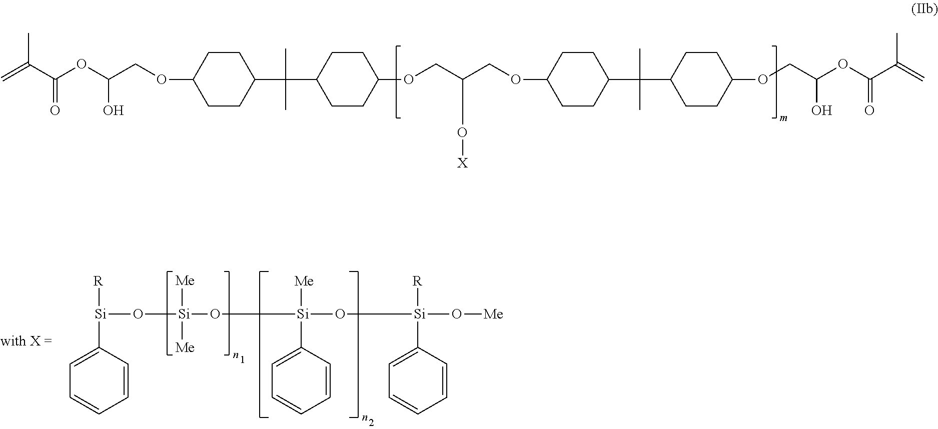
where R=identical or different, linear or branched alkyl radicals with 1 to 18 C atoms, n₁ is between 4 and 70, n₂ is between 4 and 70, and the sum of n from n₁+n₂ is between 4 to 70, and with m=1-20.

11. A coating composition comprising the silicone-epoxy resin according to claim 9.

12. The coating composition according to claim 11, comprising at least one solvent selected from the group consisting of esters, ketones, aromatics and alcohols.

13. The coating composition according to claim 11, comprising at least one radical-forming photoinitiator.

14. A protective layer in a semiconductor element comprising the coating composition of claim 11.

15. A coating composition comprising the silicone-epoxy resin according to claim 10.

16. The coating composition according to claim 15, comprising at least one solvent selected from the group consisting of esters, ketones, aromatics and alcohols.

17. A protective layer in a semiconductor element comprising the coating composition of claim 15.

18. The process according to claim 2, wherein the radicals R¹ or R³ is an alkoxy group.

19. The process according to claim 2, wherein the radical R² is an alkyl group or hydrogen.

20. The process according to claim 2, wherein the radical R² is an alkyl group.
